(19) United States
(12) Patent Application Publication
(10) Pub. No.: US 2025/0361247 A1
(43) Pub. Date: Nov. 27, 2025

(54) HIGH-STABILITY BORON-BASED MAGNESIUM SALT, AND EFFICIENT AND LARGE-SCALE PREPARATION METHOD AND USE THEREOF

(71) Applicant: Chongqing Inst. of New Ene. Stor. Mater. & Equip., Yubei District (CN)

(72) Inventors: Jingfeng WANG, Yubei District (CN); Zhimeng TANG, Yubei District (CN); Xianquan JIANG, Yubei District (CN); Baihua QU, Yubei District (CN); Hongxing JIA, Yubei District (CN); Zhenyu ZHANG, Yubei District (CN); Fusheng PAN, Yubei District (CN)

(21) Appl. No.: 18/828,423

(22) Filed: Sep. 9, 2024

(30) Foreign Application Priority Data
May 23, 2024 (CN) 202410649286.X

(51) Int. Cl. C07F 5/04; B01D 3/10; H01M 10/0568

(52) U.S. Cl. CPC C07F 5/04; B01D 3/10; H01M 10/0568; H01M 2300/0025

(57) ABSTRACT

A high-stability boron-based magnesium salt, and an efficient and large-scale preparation method and use thereof are provided. The method includes subjecting a boron source and a magnesium source to a first reaction in an organic solvent to obtain a first reaction system; subjecting the first reaction system and an alcohol source to a second reaction to obtain a second reaction system; and adding a poor solvent into the second reaction system to obtain a precipitate, washing the precipitate, and subjecting a resulting washed precipitate to vacuum distillation and drying in sequence to obtain the boron-based magnesium salt.

### CROSS REFERENCE TO RELATED APPLICATION

This patent application claims the benefit and priority of Chinese Patent Application No. 202410649286X filed with the China National Intellectual Property Administration on May 23, 2024, the disclosure of which is incorporated by reference herein in its entirety as part of the present application.

### TECHNICAL FIELD

The present disclosure belongs to the technical field of magnesium ion batteries, and specifically relates to a high-stability boron-based magnesium salt, and an efficient and large-scale preparation method and use thereof.

### BACKGROUND

With the development of energy storage technologies, a demand for higher energy density storage is driving research beyond the currently dominant lithium-ion batteries. Replacing monovalent Li⁺ with multivalent ions is an effective approach for achieving commercial rechargeable batteries of high energy density. Magnesium (Mg) metal, due to abundant reserves (ranked 8th among crustal elements), low reduction potential (−2.356 V vs. SHE), low probability of dendrite formation, and high volume energy density (3,833 mAh/cm³), has been regarded as one of the most promising new energy storage technologies.

However, at present, the lack of suitable electrolytes remains a key challenge in building rechargeable magnesium batteries with high energy density. So far, researchers at home and abroad have achieved reversible electrochemistry by coordinating Mg²⁺ in various magnesium salts with ether oxygen groups of ether solvents as well as compounds with large steric volume and weakly coordinated anions. Boron-based magnesium salts have particularly outstanding performance. Especially, Mg[B(Ohfip)₄)₂ exhibits high oxidation stability (remaining stable at a voltage of about 4V, relative to magnesium electrodes), high ionic conductivity, and excellent Mg deposition coulombic efficiency, making the Mg[B(Ohfip)₄)₂ a promising candidate in the current chlorine-free magnesium electrolytes. Currently, boron-based magnesium salts for magnesium batteries are prepared by a two-step process or a replacement process in an argon atmosphere glove box. However, the above processes have problems such as high cost of raw materials, complex equipment required for reaction, harsh reaction conditions, high energy consumption, long time, poor yield, and high humidity sensitivity, and are not suitable for large-scale production. Therefore, it is crucial to develop a simple, efficient, and scalable preparation method of the boron-based magnesium salt to meet the demand for mass production of high-quality boron-based magnesium salts for magnesium batteries.

Chinese patent application No. 202310041131.3 discloses a method for preparing a boron-based magnesium salt. In this method, magnesium borohydride is directly used as a raw material, which is expensive and easy to explode, contains impurities such as chloride ions, and easily results in by-products. The preparation needs to be conducted in a glove box, showing difficult temperature control and low output, and is not suitable for large-scale production.

Japanese patent publication No. JP2021178801A discloses a method for preparing a boron-based magnesium salt. The method adopts a two-step synthesis process, where a magnesium salt Mg(Ohfip)₂ is synthesized, and then further reacts with a boron salt B(Ohfip)₃ generated by reaction of a boron source and an alcohol source to obtain magnesium borate. This method has a complex preparation process, with long time and high humidity sensitivity, which needs to be conducted in a glove box, making it difficult to control the temperature and therefore not suitable for large-scale production.

### SUMMARY

In view of the problems that the existing boron-based magnesium salt synthesis shows high raw materials cost, long time, and low yield, and is difficult to meet the large-scale industrial production, the present disclosure provides a novel method for preparing a boron-based magnesium salt. In the method, a simple and efficient anion exchange process is adopted to generate a borohydride in situ during reaction to prepare the boron-based magnesium salt. The method does not introduce other metal cations and chloride ions, results in both high yield and purity, and exhibits excellent product performance.

To achieve the above objects, the present disclosure provides the following technical solutions.

The present disclosure provides an efficient and large-scale method for preparing a high-stability boron-based magnesium salt, including the following steps:
step 1, subjecting a boron source and a magnesium source to first reaction in an organic solvent to obtain a first reaction system;
step 2, subjecting the first reaction system and an alcohol source to second reaction to obtain a second reaction system; and
step 3, adding a poor solvent into the second reaction system to obtain a precipitate, washing the precipitate, and subjecting a resulting washed precipitate to vacuum distillation and drying in sequence to obtain the boron-based magnesium salt.

In some embodiments, the organic solvent includes one selected from the group consisting of a non-polar solvent and an ether solvent, the non-polar solvent including one or more selected from the group consisting of toluene, hexane, petroleum ether, pentane, dimethylpentane, isooctane, and heptane, and the ether solvent including one or more selected from the group consisting of thioether, tetrahydrofuran, ethylene glycol dimethyl ether (DME), diethylene glycol dimethyl ether, triethylene glycol dimethyl ether, and tetraethylene glycol dimethyl ether.

In some embodiments, the boron source includes at least one selected from the group consisting of borane and a borane complex, the borane complex including one or more selected from the group consisting of a dimethyl sulfide-borane complex, a borane-triethylamine (TEA) complex, a borane-tetrahydrofuran complex, a borane-ammonia complex, an N,N-dimethylaniline (DMA)-borane complex, and 1,2-diaryl-o-carborane.

In some embodiments, the magnesium source includes at least one selected from the group consisting of magnesium dihydride and an alkyl magnesium salt, the alkyl magnesium salt is one or more selected from the group consisting of diethyl magnesium, di-n-butyl magnesium, di-sec-butyl magnesium, dibutyl(isopropyl) magnesium, di-n-butyl ethyl magnesium, and n-butyl sec-butyl magnesium.

In some embodiments, the alcohol source includes at least one selected from the group consisting of a monohydric alcohol compound and a polyhydric alcohol compound;

the monohydric alcohol compound includes one or more selected from the group consisting of ethanol, difluoroethanol, trifluoroethanol, 1-phenyl-2,2,2-trifluoroethanol, isopropanol, 1,3-dibromo-2-propanol, 2-phenylisopropanol, trifluoropropanol, trifluoroisopropanol, hexafluoroisopropanol, perfluoro-tert-butyl alcohol, 2-trifluoromethyl-2-propanol, 3-perfluorobutyl propanol, 1,1,1,3,3,3-hexafluoro-2-phenyl-2-propanol, 2,2-bis(trifluoromethyl) propanol, tetrahydropyran-4-ol, and tetrahydrofuryl alcohol; and

the polyhydric alcohol compound includes one or more selected from the group consisting of ethylene glycol, 2,3-butanediol, 2,3-diphenyl-2,3-butanediol, 2,3-dimethyl-2,3-butanediol, 1,2,4-butanetriol, and hexafluoro-2,3-bis(trifluoromethyl)-2,3-butanediol.

In some embodiments, a dosage ratio of the boron source to the organic solvent is in a range of 1 mmol: 0.5-2.5 mL;
a dosage ratio of the magnesium source to the organic solvent is in a range of 1 mmol: 1.0-6.0 mL;
a molar ratio of the boron source to the magnesium source is in a range of 1.5-4.0:1.0; and
a molar ratio of the magnesium source to the alcohol source is in a range of 1.0:8.5-12.5.

In some embodiments, the first reaction in step 1 is conducted at a temperature of −5° C. to 110° C. and a pressure of 0 MPa to 15 MPa for 5 min to 180 min; and
the second reaction in step 2 is conducted at a temperature of −5° C. to 110° C. and a pressure of 0 MPa to 15 MPa for 5 min to 120 min.

In some embodiments, the poor solvent includes one or more selected from the group consisting of toluene, n-hexane, cyclohexane, petroleum ether, n-pentane, isopentane, dimethylpentane, cyclopentane, isooctane, and heptane;
a volume ratio of the second reaction system to the poor solvent is in a range of 1:0.5-2;
the vacuum distillation is conducted at a temperature of 30° C. to 60° C. for 5 min to 180 min; and
the drying includes at least one selected from the group consisting of vacuum drying and forced air drying, and the drying is conducted at a temperature of 50° C. to 90° C. for 2 h to 24 h.

The present disclosure further provides a high-stability boron-based magnesium salt prepared by the method described in the above technical solutions.

The present disclosure further provides use of the high-stability boron-based magnesium salt described in the above technical solutions in an electrolyte of a magnesium battery.

The present disclosure provides an efficient and large-scale method for preparing a high-stability boron-based magnesium salt, including the following steps: step 1, subjecting a boron source and a magnesium source to first reaction in an organic solvent to obtain a first reaction system; step 2, subjecting the first reaction system and an alcohol source to second reaction to obtain a second reaction system; and step 3, adding a poor solvent into the second reaction system to obtain a precipitate, washing the precipitate, and subjecting a resulting washed precipitate to vacuum distillation and drying in sequence to obtain the boron-based magnesium salt.

Comparing with the prior art, some embodiments of the present disclosure have the following beneficial effects:

In the present disclosure, an anion exchange method is adopted. During the synthesis, borohydride is generated in situ, and then reacts with an alcohol source to quickly obtain a boron-based magnesium salt. The method has a simple and efficient process, does not introduce other metal cations and chloride ions, and exhibits low raw material cost, and could achieve large-scale production with a yield of 79% to 96%. Compared with the existing two-step method, the method has a preparation efficiency that could be increased by not less than 80%, and could reduce a preparation cost by up to 93% compared with directly using magnesium borohydride as a raw material. The boron-based magnesium salt prepared by the method shows a desirable stability to air and water, high yield, high purity, and excellent conductivity. In addition, the method has safety, high efficiency, cleanness, environmental protection, and low energy consumption, and is suitable for industrial large-scale production.

### BRIEF DESCRIPTION OF THE DRAWINGS

FIG. 1 shows a scanning electron microscopy (SEM) image of the intermediate product borohydride prepared under an argon atmosphere in Example 1;

FIG. 2 shows an X-ray diffraction (XRD) pattern of the intermediate product borohydride prepared under an argon atmosphere in Example 1;

FIG. 3 shows an SEM image of the magnesium hexafluoroisopropoxyborate prepared under an argon atmosphere in Example 1;

FIG. 4 shows electrospray ionization-mass spectrometry (ESI-MS) spectra of the magnesium hexafluoroisopropoxyborate prepared under different atmospheres in Example 1;

FIG. 5 shows nuclear magnetic resonance (NMR)¹H spectra of the magnesium hexafluoroisopropoxyborate prepared under an argon atmosphere in Example 1 under different storage conditions;

FIG. 6 shows NMR ¹¹B spectra of the magnesium hexafluoroisopropoxyborate prepared under an argon atmosphere in Example 1 under different storage conditions;

FIG. 7 shows NMR ¹⁹F spectra of the magnesium hexafluoroisopropoxyborate prepared under argon atmosphere in Example 1 under different storage conditions;

FIG. 8 shows a cycling performance diagram of a Mg|Mg[B(Ohfip)₄]₂/DME|Mg symmetric cell of the boron-based magnesium salt prepared under an argon atmosphere in Example 1 at a current density of 1 mAh; and

FIG. 9 shows a coulombic efficiency diagram of a Mg|Mg[B(Ohfip)₄]₂/DME|Cu asymmetric cell of the boron-based magnesium salt prepared under an argon atmosphere in Example 1 at a current density of 1 mAh.

### DETAILED DESCRIPTION OF THE EMBODIMENTS

The present disclosure provides an efficient and large-scale method for preparing a high-stability boron-based magnesium salt, including the following steps:
step 1, subjecting a boron source and a magnesium source to first reaction in an organic solvent to obtain a first reaction system;
step 2, subjecting the first reaction system and an alcohol source to second reaction to obtain a second reaction system; and
step 3, adding a poor solvent into the second reaction system to obtain a precipitate, washing the precipitate, and subjecting a resulting washed precipitate to vacuum distillation and drying in sequence to obtain the boron-based magnesium salt.

In the present disclosure, unless otherwise specified, all raw materials for preparation are commercially available products well known to those skilled in the art.

In the present disclosure, a boron source and a magnesium source are subjected to first reaction in an organic solvent to obtain a first reaction system.

In some embodiments of the present disclosure, the boron source includes at least one selected from the group consisting of borane and a borane complex, the borane complex including one or more selected from the group consisting of a dimethyl sulfide-borane complex, a borane-TEA complex, a borane-tetrahydrofuran complex, a borane-ammonia complex, a DMA-borane complex, and 1,2-diaryl-o-carborane. In some embodiments of the present disclosure, the boron source has a purity of 95% to 99.9%.

In some embodiments of the present disclosure, the magnesium source includes at least one selected from the group consisting of magnesium dihydride and an alkyl magnesium salt, the alkyl magnesium salt including one or more selected from the group consisting of diethyl magnesium, di-n-butyl magnesium, di-sec-butyl magnesium, dibutyl(isopropyl) magnesium, di-n-butyl ethyl magnesium, and n-butyl sec-butyl magnesium.

In some embodiments of the present disclosure, the organic solvent includes one selected from the group consisting of a non-polar solvent and an ether solvent, and preferably the non-polar solvent. In some embodiments of the present disclosure, the non-polar solvent includes one or more selected from the group consisting of toluene, hexane, petroleum ether, pentane, dimethylpentane, isooctane, and heptane, and the ether solvent includes one or more selected from the group consisting of thioether, tetrahydrofuran, DME, diethylene glycol dimethyl ether, triethylene glycol dimethyl ether, and tetraethylene glycol dimethyl ether. In some embodiments of the present disclosure, the organic solvent has a purity of greater than 95%.

In some embodiments of the present disclosure, a dosage ratio of the boron source to the organic solvent is in a range of 1 mmol: 0.5-2.5 mL. In some embodiments of the present disclosure, a dosage ratio of the magnesium source to the organic solvent is in a range of 1 mmol: 1.0-6.0 mL. In some embodiments of the present disclosure, a molar ratio of the boron source to the magnesium source is in a range of 1.5-4.0:1.0.

In some embodiments of the present disclosure, subjecting the boron source and the magnesium source to the first reaction in the organic solvent includes: dissolving the boron source in the organic solvent, then adding the magnesium source, and subjecting a resulting system to the first reaction.

In some embodiments of the present disclosure, the magnesium source is added in the form of an organic solution containing the magnesium source. In some embodiments of the present disclosure, a solvent in the organic solution containing the magnesium source includes at least one selected from the group consisting of a non-polar organic solvent and an ether organic solvent. There is no particular limitation on a concentration of the organic solution containing the magnesium source, and any concentration known to those skilled in the art may be adopted.

In some embodiments of the present disclosure, the first reaction is conducted at a temperature of −5° C. to 110° C. and a pressure of 0 MPa to 15 MPa for 5 min to 180 min.

In some embodiments of the present disclosure, the first reaction is conducted under stirring at a rotation speed of 50 rpm to 1,500 rpm. In some embodiments of the present disclosure, the first reaction is conducted in an atmospheric atmosphere or a protective atmosphere. In some embodiments of the present disclosure, the atmospheric atmosphere has an ambient humidity of less than 70%, In some embodiments of the present disclosure, the protective atmosphere is an inert atmosphere, and preferably argon.

In some embodiments of the present disclosure, after the first reaction system is obtained, it is directly subjected to the next step without any post-treatment.

In the present disclosure, after the first reaction system is obtained, the first reaction system and an alcohol source are subjected to second reaction to obtain a second reaction system.

In some embodiments of the present disclosure, the alcohol source includes at least one selected from the group consisting of a monohydric alcohol compound and a polyhydric alcohol compound, where the monohydric alcohol compound includes one or more selected from the group consisting of ethanol, difluoroethanol, trifluoroethanol, 1-phenyl-2,2,2-trifluoroethanol, isopropanol, 1,3-dibromo-2-propanol, 2-phenylisopropanol, trifluoropropanol, trifluoroisopropanol, hexafluoroisopropanol, perfluoro-tert-butyl alcohol, 2-trifluoromethyl-2-propanol, 3-perfluorobutyl propanol, 1,1,1,3,3,3-hexafluoro-2-phenyl-2-propanol, 2,2-bis(trifluoromethyl) propanol, tetrahydropyran-4-ol, and tetrahydrofuryl alcohol, and the polyhydric alcohol compound includes one or more selected from the group consisting of ethylene glycol, 2,3-butanediol, 2,3-diphenyl-2,3-butanediol, 2,3-dimethyl-2,3-butanediol, 1,2,4-butanetriol, and hexafluoro-2,3-bis(trifluoromethyl)-2,3-butanediol. In some embodiments of the present disclosure, the alcohol source has a purity of 95% to 99.7%. In some embodiments of the present disclosure, a molar ratio of the magnesium source to the alcohol source is in a range of 1.0:8.5-12.5.

In some embodiments of the present disclosure, the order of mixing the first reaction system with the alcohol source is as follows: adding the alcohol source into the first reaction system. In some embodiments of the present disclosure, the second reaction is conducted under stirring at a temperature of −5° C. to 110° C. and a pressure of 0 MPa to 15 MPa for 5 min to 120 min.

In some embodiments of the present disclosure, after the second reaction system is obtained, it is to directly proceed to the next step without any post-treatment.

In the present disclosure, after the second reaction system is obtained, a poor solvent is added into the second reaction system, an obtained precipitate is washed, and the precipitate is subjected to vacuum distillation and drying in sequence to obtain a boron-based magnesium salt.

In some embodiments of the present disclosure, the poor solvent includes one or more selected from the group consisting of toluene, n-hexane, cyclohexane, petroleum ether, n-pentane, isopentane, dimethylpentane, cyclopentane, isooctane, and heptane. In some embodiments of the present disclosure, the poor solvent has a purity of greater than 97%. In some embodiments of the present disclosure, a volume ratio of the second reaction system to the poor solvent is in a range of 1:0.5-2.

In the present disclosure, there is no special limitation on a washing process, and the washing process known to those skilled in the art may be adopted. In some embodiments of the present disclosure, the washing is repeated 3 times.

In some embodiments of the present disclosure, the vacuum distillation is conducted at a temperature of 30° C. to 60° C. for 5 min to 180 min. In some embodiments of the present disclosure, the drying preferably includes at least one selected from the group consisting of vacuum drying and forced air drying. In some embodiments of the present disclosure, the drying is conducted at a temperature of 50° C. to 90° C. for 2 h to 24 h.

In some embodiments of the present disclosure, the boron-based magnesium salt has a yield of 79% to 96%.

In some embodiments of the present disclosure, a reaction mechanism for preparing the boron-based magnesium salt is as follows:

$$8 {BH}_{3} - {R}_{1} + 3 {Mg [ {R}_{2} ]}_{2} \to 3 {Mg ( {BH}_{4} )}_{2} \cdot 2 {R}_{1} + 2 {B ( {R}_{2} )}_{3} {R}_{1} \qquad Formula 1$$

$${Mg ( {BH}_{4} )}_{2} \cdot 2 {R}_{1} + 9 {R}_{3} OH ( excess ) \to {Mg [ {B ( {O R}_{3} )}_{4} ]}_{2} + 8 {H}_{2} ↑ \qquad Formula 2$$

In some embodiments of the present disclosure, a specific process is as follows: reacting a boron source with a magnesium source by anion exchange to generate a borohydride (Formula 1), and to directly reacting the borohydride with an alcohol source to generate the boron-based magnesium salt (Formula 2). The method has simple synthesis steps, in-situ generation of borohydride during the reaction, does not introduce other metal cations and chloride ions, and exhibits low cost.

The present disclosure further provides a high-stability boron-based magnesium salt prepared by the method described in the above technical solutions.

The present disclosure further provides use of the high-stability boron-based magnesium salt described in the above technical solutions in an electrolyte of a magnesium battery. In the present disclosure, there is no special limitation on a specific implementation mode of the use, and a process well known to those skilled in the art may be adopted.

In order to further illustrate the present disclosure, the high-stability boron-based magnesium salt, and the efficient and large-scale preparation method and the use thereof provided by the present disclosure are described in detail below with reference to drawings and examples, but these drawings and the examples should not be understood as limiting the scope of the present disclosure.

### Example 1

Raw materials were measured according to 50 mmol of a dimethyl sulfide-borane complex, 98% n-hexane organic solvent, di-n-butyl magnesium hexane solution (containing 20 mmol of di-n-butyl magnesium), and 175.0 mmol of 99.5% hexafluoroisopropanol.

(1) In an atmosphere of air (ambient humidity <70%) or argon, the dimethyl sulfide-borane complex was dissolved in 45 mL of n-hexane organic solvent to obtain a mixed solution. The di-n-butyl magnesium hexane solution was added into the mixed solution. A resulting system was subjected to first reaction under stirring at 300 rpm, 20° C., and 0.2 MPa for 60 min to obtain a first reaction system.

(2) The hexafluoroisopropanol was added into the first reaction system. A resulting system was subjected to second reaction under stirring at 300 rpm, 0° C., and 0.2 MPa for 20 min to obtain a second reaction system.

(3)80 mL of n-hexane was added into the second reaction system to obtain a precipitate. The precipitate was washed repeatedly 3 times. A supernatant was removed, and a resulting washed precipitate was subjected to vacuum distillation at 40° C. for 20 min and vacuum drying at 70° C. for 12 h in sequence to obtain 29.6 g of magnesium salt crystals Mg[B(Ohfip)₄]₂ with a yield of 90%.

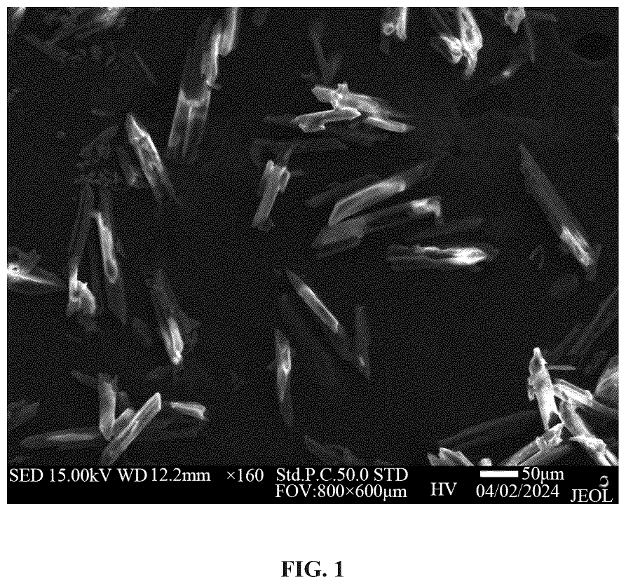

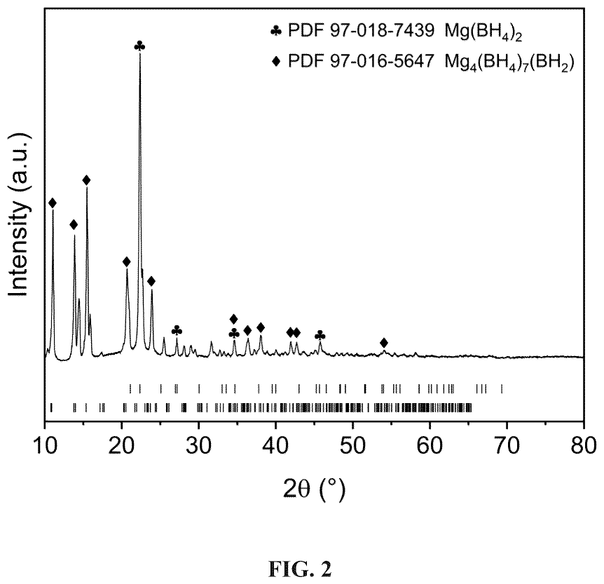

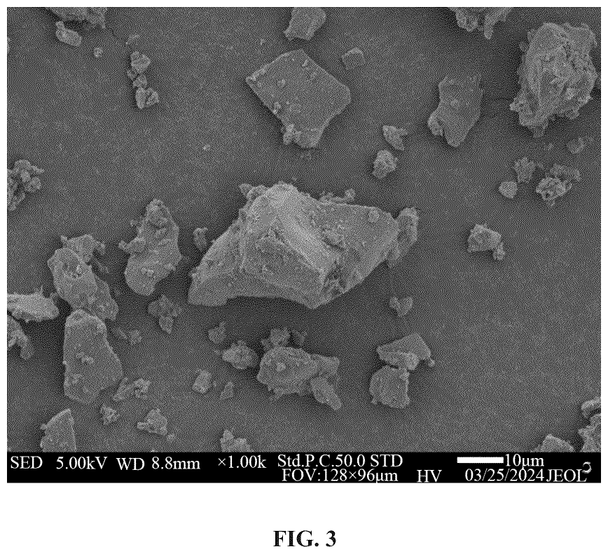

FIG. 1 shows a SEM image of the intermediate product borohydride (the first reaction system) prepared under an argon atmosphere in Example 1; FIG. 2 shows an XRD pattern of the intermediate product borohydride prepared under an argon atmosphere in Example 1; and FIG. 3 shows a SEM image of the magnesium hexafluoroisopropoxyborate prepared under an argon atmosphere in Example 1. As shown in FIG. 1 and FIG. 2, during the preparation, a boron source and a magnesium source react to generate borohydride; and then the magnesium hexafluoroisopropoxyborate is successfully prepared by reacting with hexafluoroisopropanol (FIG. 3).

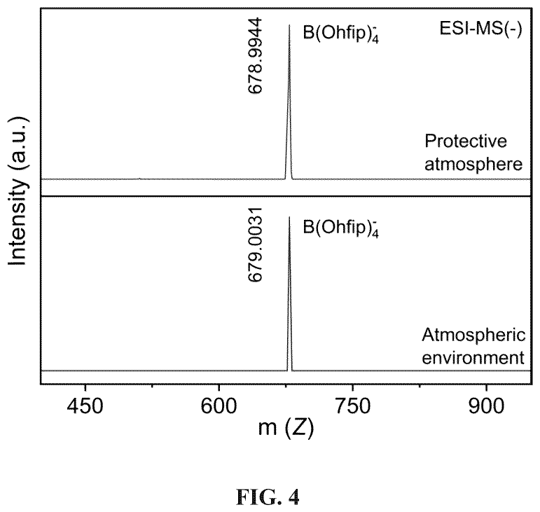

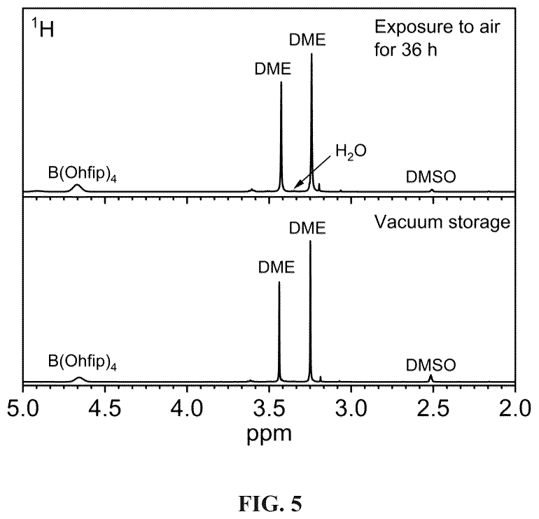

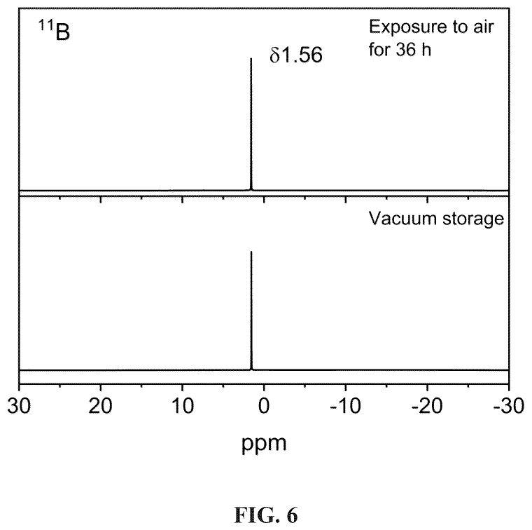

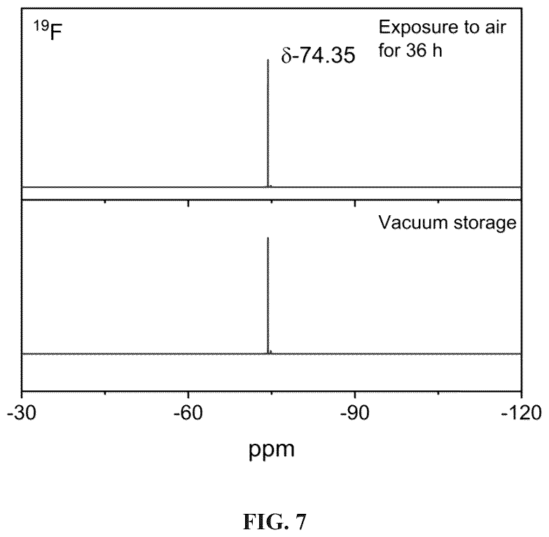

FIG. 4 shows ESI-MS spectra of the magnesium hexafluoroisopropoxyborate prepared under different atmospheres in Example 1; FIG. 5 shows NMR 1H spectra of the magnesium hexafluoroisopropoxyborate prepared under an argon atmosphere in Example 1 under different storage conditions; FIG. 6 shows NMR ¹¹B spectra of the magnesium hexafluoroisopropoxyborate prepared under an argon atmosphere in Example 1 under different storage conditions; and FIG. 7 shows NMR ¹⁹F spectra of the magnesium hexafluoroisopropoxyborate prepared under argon atmosphere in Example 1 under different storage conditions. As shown in the ESI-MS spectra and NMR ¹H, ¹¹B, and ¹⁹F analyses in FIG. 4 to FIG. 7, the prepared magnesium borate has high purity, no by-products, and desirable stability to air and water.

### Example 2

Raw materials were measured according to 50 mmol of a borane-tetrahydrofuran complex, 99.5% toluene organic solvent, n-hexane organic solvent with purity >98%, di-n-butyl magnesium heptane solution (containing 20 mmol of di-n-butyl magnesium), and 175 mmol of 99.5% hexafluoroisopropanol.

(1) In an atmosphere of argon, the borane-tetrahydrofuran complex was dissolved in 50 mL of the toluene organic solvent to obtain a mixed solution. The di-n-butyl magnesium heptane solution was added into the mixed solution. A resulting system was subjected to first reaction under stirring at 300 rpm, 0° C., and 0.1 MPa for 80 min to obtain a first reaction system.

(2) The hexafluoroisopropanol was added into the first reaction system. A resulting system was subjected to second reaction under stirring at 300 rpm, 0° C., and 0.1 MPa for 30 min to obtain a second reaction system.

(3)100 mL of n-hexane was added into the second reaction system to obtain a precipitate. The precipitate was washed repeatedly 3 times. A supernatant was removed, and a resulting washed precipitate was subjected to vacuum distillation at 40° C. for 20 min and vacuum drying at 70° C. for 16 h in sequence to obtain 31.0 g of magnesium salt crystals Mg[B(Ohfip)₄]₂ with a yield of 94%.

### Example 3

Raw materials were measured according to 50 mmol of a borane-ammine complex, 99.5% tetrahydrofuran organic solvent, AR-grade petroleum ether, di-n-butyl magnesium tetrahydrofuran solution (containing 20 mmol of di-n-butyl magnesium), and 180.0 mmol of 99.7% ethanol.

(1) In an atmosphere of argon, the borane-ammine complex was dissolved in 50 mL of tetrahydrofuran organic solvent to obtain a mixed solution. The di-n-butyl magnesium tetrahydrofuran solution was added into the mixed solution. A resulting system was subjected to first reaction under stirring at 300 rpm, 5° C., and 0.5 MPa for 120 min to obtain a first reaction system.

(2) The ethanol was added into the first reaction system. A resulting system was subjected to second reaction under stirring at 300 rpm, 0° C., and 0.5 MPa for 40 min to obtain a second reaction system.

(3)100 mL of AR-grade petroleum ether was added into the second reaction system to obtain a precipitate. The precipitate was washed repeatedly 3 times. A supernatant was removed, and a resulting washed precipitate was subjected to vacuum distillation at 30° C. for 20 min and vacuum drying at 45° C. for 12 h in sequence to obtain 30.2 g of magnesium salt crystals Mg[B(Ohfip)₄]₂ with a yield of 91%.

### Example 4

Raw materials were measured according to 50 mmol of a DMA-borane complex, 99.5% DME organic solvent, AR-grade n-pentane, n-butyl sec-butyl magnesium heptane solution (containing 20 mmol of n-butyl sec-butyl magnesium), and 200.0 mmol of 99.5% trifluoroethanol.

(1) In an atmosphere of argon, 50 mmol of the DMA-borane complex was dissolved in 50 mL of DME organic solvent to obtain a mixed solution. The n-butyl sec-butyl magnesium heptane solution was added into the mixed solution. A resulting system was subjected to first reaction under stirring at 300 rpm, 15° C., and 0.5 MPa for 160 min to obtain a first reaction system.

(2) The trifluoroethanol was added into the first reaction system. A resulting system was subjected to second reaction under stirring at 300 rpm, 0° C., and 0.5 MPa for 50 min to obtain a second reaction system.

(3)100 mL of AR-grade n-pentane was added into the second reaction system to obtain a precipitate. The precipitate was washed repeatedly 3 times. A supernatant was removed, and a resulting washed precipitate was subjected to vacuum distillation at 35° C. for 30 min and vacuum drying at 50° C. for 12 h in sequence to obtain 28.7 g of magnesium salt crystals Mg[B(Otfe)₄]₂ with a yield of 87%.

### Example 5

Raw materials were measured according to 60 mmol of a borane-TEA complex, 80 mL of 99.5% triethylene glycol dimethyl ether organic solvent, isooctane with a purity of >99%, di-n-butyl ethyl magnesium hexane solution (containing 20 mmol of n-butyl sec-butyl magnesium), and 200.0 mmol of 99% perfluoro-tert-butyl alcohol.

(1) In an atmosphere of argon, the borane-TEA complex was dissolved in 80 mL of triethylene glycol dimethyl ether organic solvent to obtain a mixed solution. The di-n-butyl ethyl magnesium hexane solution was added into the mixed solution. A resulting system was subjected to first reaction under stirring at 300 rpm, 10° C., and 0.5 MPa for 180 min to obtain a first reaction system.

(2) The perfluoro-tert-butyl alcohol was added into the first reaction system. A resulting system was subjected second reaction under stirring at 300 rpm, 0° C., and 0.5 MPa for 60 min to obtain a second reaction system.

(3)100 mL of isooctane was added into the second reaction system to obtain a precipitate. The precipitate was washed repeatedly 3 times. A supernatant was removed, and a resulting washed precipitate was subjected to vacuum distillation at 40° C. for 20 min and vacuum drying at 80° C. for 24 h in sequence to obtain 26.8 g of magnesium salt crystals Mg(BH(Opftb)₃)₂ with a yield of 81%.

### Example 6

Raw materials were measured according to 60 mmol of a borane-tetrahydrofuran complex, 98% n-hexane organic solvent, n-hexane di-n-butyl magnesium heptane solution with a purity of >98% (containing 20 mmol of di-n-butyl magnesium), and 250 mmol of 98% hexafluoro-2,3-bis(trifluoromethyl)-2,3-butanediol.

(1) In an atmosphere of argon, the borane-tetrahydrofuran complex was dissolved in n-hexane organic solvent to obtain a mixed solution. The di-n-butyl magnesium heptane solution was added into the mixed solution. A resulting system was subjected to first reaction under stirring at 300 rpm, 25° C., and 0.2 MPa for 20 min to obtain a first reaction system.

(2) The hexafluoro-2,3-bis(trifluoromethyl)-2,3-butanediol was added into the first reaction system. A resulting system was subjected to second reaction under stirring at 300 rpm, 60° C., and 0.2 MPa for 120 min to obtain a second reaction system.

(3)100 mL of n-hexane was added into the second reaction system to obtain a precipitate. The precipitate was washed repeatedly 3 times. A supernatant was removed, and a resulting washed precipitate was subjected to vacuum distillation at 40° C. for 20 min and vacuum drying at 70° C. for 10 h in sequence to obtain 29.8 g of magnesium salt crystals MgFPB with a yield of 90%.

### Use Example

### 1. Preparation of Electrolyte System

The magnesium hexafluoroisopropoxyborate under an argon atmosphere obtained in Example 1 was added into a solution of DME at a water oxygen content of less than 0.01 ppm to obtain an electrolyte having a magnesium salt concentration of 0.3 M (mol/L).

### 2. Preparation of Batteries and Testing of Decomposition Voltage

Magnesium-magnesium symmetric cell test method: Mg/Mg battery assembly test was adopted, where negative electrode shell, spring, gasket, magnesium sheet, GF/D glass fiber diaphragm, magnesium sheet, and positive electrode shell were assembled in sequence. (60-100) μL of the electrolyte was added into each battery to wet the diaphragm, and finally the battery was encapsulated. The battery was left alone for 5 min and then the cycle performance was tested at a current density of 1 mA/cm².

Magnesium-copper coulombic efficiency test method: Mg/Cu battery assembly test was adopted, where negative electrode shell, spring, gasket, magnesium sheet, GF/D glass fiber diaphragm, copper sheet, and positive electrode shell were assembled in sequence. (60-100) μL of the electrolyte was added into each battery to wet the diaphragm, and finally the battery was encapsulated. The battery was pre-charged and pre-discharged at a current density of 0.1 mA/cm² under a voltage of 0 V to 1.5 V, and then deposited at a current density of 1.0 mA/cm² for 30 min and then stripped at a current density of 1.0 mA/cm² under a voltage of 0 V to 1.2 V until the voltage was higher than 1.2 V, and the coulombic efficiency was calculated. A formula was: coulombic efficiency=discharge capacity/charge capacity.

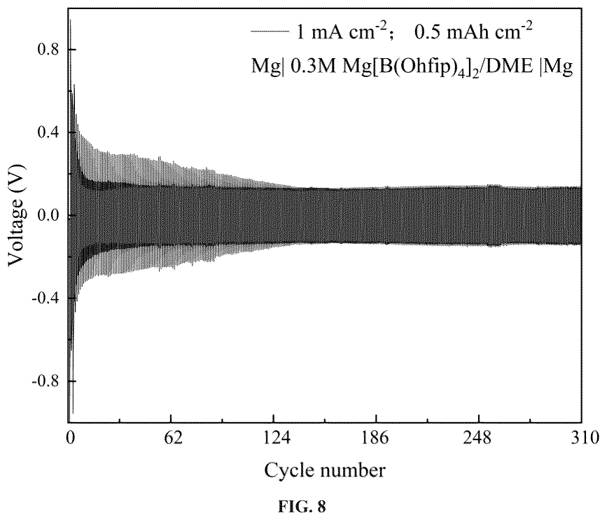

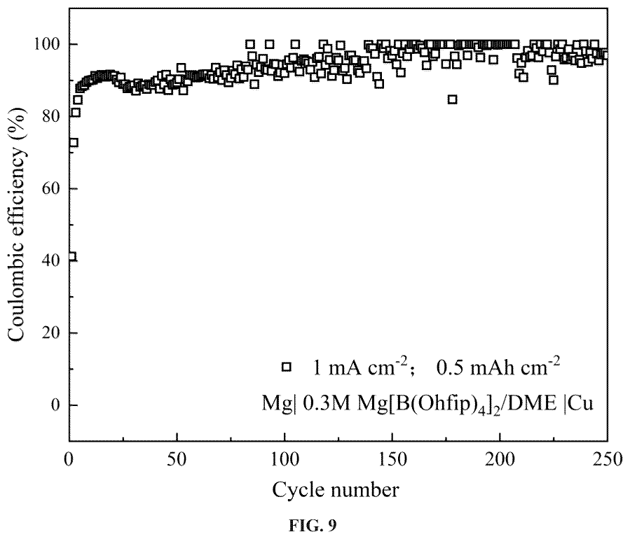

The test results are shown in FIG. 8 and FIG. 9. FIG. 8 shows a cycling performance diagram of the Mg|Mg[B(Ohfip)₄]₂/DME|Mg symmetric cell of the boron-based magnesium salt prepared under an argon atmosphere in Example 1 at a current density of 1 mAh; and FIG. 9 shows a coulombic efficiency diagram of the Mg|Mg[B(Ohfip)₄]₂/DME|Cu asymmetric cell of the boron-based magnesium salt prepared under an argon atmosphere in Example 1 at a current density of 1 mAh.

From the test performance of the symmetric cell and the asymmetric cell in FIG. 8 and FIG. 9, it is found that the electrolyte prepared by the magnesium hexafluoroisopropoxyborate had desirable cycle performance (>300 cycles), low overpotential (0.15 V), and high coulombic efficiency (94.34%).

Although the present disclosure is described in detail in conjunction with the foregoing examples, they are only a part of, not all of, the embodiments of the present disclosure. Other embodiments can be obtained based on these embodiments without creative efforts, and all of these embodiments shall fall within the scope of the present disclosure.

1. A method for preparing a boron-based magnesium salt, comprising:
subjecting a boron source and a magnesium source to a first reaction in an organic solvent to obtain a first reaction system;
subjecting the first reaction system and an alcohol source to a second reaction to obtain a second reaction system; and
adding a poor solvent into the second reaction system to obtain a precipitate, washing the precipitate, and subjecting a resulting washed precipitate to vacuum distillation and drying in sequence to obtain the boron-based magnesium salt.

2. The method of claim 1, wherein the organic solvent comprises one selected from the group consisting of a non-polar solvent and an ether solvent, the non-polar solvent comprising at least one selected from the group consisting of toluene, hexane, petroleum ether, pentane, dimethylpentane, isooctane, and heptane, and the ether solvent comprising at least one selected from the group consisting of thioether, tetrahydrofuran, ethylene glycol dimethyl ether (DME), diethylene glycol dimethyl ether, triethylene glycol dimethyl ether, and tetraethylene glycol dimethyl ether.

3. The method of claim 1, wherein the boron source comprises at least one selected from the group consisting of borane and a borane complex, the borane complex comprising at least one selected from the group consisting of a dimethyl sulfide-borane complex, a borane-triethylamine (TEA) complex, a borane-tetrahydrofuran complex, a borane-ammonia complex, an N,N-dimethylaniline (DMA)-borane complex, and 1,2-diaryl-o-carborane.

4. The method of claim 1, wherein the magnesium source comprises at least one selected from the group consisting of magnesium dihydride and an alkyl magnesium salt, the alkyl magnesium salt comprising at least one selected from the group consisting of diethyl magnesium, di-n-butyl magnesium, di-sec-butyl magnesium, dibutyl(isopropyl) magnesium, di-n-butyl ethyl magnesium, and n-butyl sec-butyl magnesium.

5. The method of claim 1, wherein the alcohol source comprises at least one selected from the group consisting of a monohydric alcohol compound and a polyhydric alcohol compound;
the monohydric alcohol compound comprises at least one selected from the group consisting of ethanol, difluoroethanol, trifluoroethanol, 1-phenyl-2,2,2-trifluoroethanol, isopropanol, 1,3-dibromo-2-propanol, 2-phenylisopropanol, trifluoropropanol, trifluoroisopropanol, hexafluoroisopropanol, perfluoro-tert-butyl alcohol, 2-trifluoromethyl-2-propanol, 3-perfluorobutyl propanol, 1,1,1,3,3,3-hexafluoro-2-phenyl-2-propanol, 2,2-bis(trifluoromethyl) propanol, tetrahydropyran-4-ol, and tetrahydrofuryl alcohol; and
the polyhydric alcohol compound comprises at least one selected from the group consisting of ethylene glycol, 2,3-butanediol, 2,3-diphenyl-2,3-butanediol, 2,3-dimethyl-2,3-butanediol, 1,2,4-butanetriol, and hexafluoro-2,3-bis(trifluoromethyl)-2,3-butanediol.

6. The method of claim 1, wherein a dosage ratio of the boron source to the organic solvent is in a range of 1 mmol: 0.5-2.5 mL;
a dosage ratio of the magnesium source to the organic solvent is in a range of 1 mmol: 1.0-6.0 mL;
a molar ratio of the boron source to the magnesium source is in a range of 1.5-4.0:1.0; and
a molar ratio of the magnesium source to the alcohol source is in a range of 1.0:8.5-12.5.

7. The method of claim 1, wherein the first reaction is conducted at a temperature of −5° C. to 110° C. and a pressure of 0 MPa to 15 MPa for 5 min to 180 min; and
the second reaction is conducted at a temperature of −5° C. to 110° C. and a pressure of 0 MPa to 15 MPa for 5 min to 120 min.

8. The method of claim 1, wherein the poor solvent comprises at least one selected from the group consisting of toluene, n-hexane, cyclohexane, petroleum ether, n-pentane, isopentane, dimethylpentane, cyclopentane, isooctane, and heptane;
a volume ratio of the second reaction system to the poor solvent is in a range of 1:0.5-2;
the vacuum distillation is conducted at a temperature of 30° C. to 60° C. for 5 min to 180 min; and
the drying comprises at least one selected from the group consisting of vacuum drying and forced air drying, and the drying is conducted at a temperature of 50° C. to 90° C. for 2 h to 24 h.

9. A boron-based magnesium salt prepared by the method of claim 1.

10. A method of using the boron-based magnesium salt of claim 9, comprising using the boron-based magnesium salt in an electrolyte of a magnesium battery.

11. The boron-based magnesium salt of claim 9, wherein the organic solvent comprises one selected from the group consisting of a non-polar solvent and an ether solvent, the non-polar solvent comprising at least one selected from the group consisting of toluene, hexane, petroleum ether, pentane, dimethylpentane, isooctane, and heptane, and the ether solvent comprising at least one selected from the group consisting of thioether, tetrahydrofuran, ethylene glycol dimethyl ether (DME), diethylene glycol dimethyl ether, triethylene glycol dimethyl ether, and tetraethylene glycol dimethyl ether.

12. The boron-based magnesium salt of claim 9, wherein the boron source comprises at least one selected from the group consisting of borane and a borane complex, the borane complex comprising at least one selected from the group consisting of a dimethyl sulfide-borane complex, a borane-triethylamine (TEA) complex, a borane-tetrahydrofuran complex, a borane-ammonia complex, an N,N-dimethylaniline (DMA)-borane complex, and 1,2-diaryl-o-carborane.

13. The boron-based magnesium salt of claim 9, wherein the magnesium source comprises at least one selected from the group consisting of magnesium dihydride and an alkyl magnesium salt, the alkyl magnesium salt comprising at least one selected from the group consisting of diethyl magnesium, di-n-butyl magnesium, di-sec-butyl magnesium, dibutyl(isopropyl) magnesium, di-n-butyl ethyl magnesium, and n-butyl sec-butyl magnesium.

14. The boron-based magnesium salt of claim 9, wherein the alcohol source comprises at least one selected from the group consisting of a monohydric alcohol compound and a polyhydric alcohol compound;
the monohydric alcohol compound comprises at least one selected from the group consisting of ethanol, difluoroethanol, trifluoroethanol, 1-phenyl-2,2,2-trifluoroethanol, isopropanol, 1,3-dibromo-2-propanol, 2-phenylisopropanol, trifluoropropanol, trifluoroisopropanol, hexafluoroisopropanol, perfluoro-tert-butyl alcohol, 2-trifluoromethyl-2-propanol, 3-perfluorobutyl propanol, 1,1,1,3,3,3-hexafluoro-2-phenyl-2-propanol, 2,2-bis(trifluoromethyl) propanol, tetrahydropyran-4-ol, and tetrahydrofuryl alcohol; and
the polyhydric alcohol compound comprises at least one selected from the group consisting of ethylene glycol, 2,3-butanediol, 2,3-diphenyl-2,3-butanediol, 2,3-dimethyl-2,3-butanediol, 1,2,4-butanetriol, and hexafluoro-2,3-bis(trifluoromethyl)-2,3-butanediol.

15. The boron-based magnesium salt of claim 9, wherein a dosage ratio of the boron source to the organic solvent is in a range of 1 mmol: 0.5-2.5 mL;
a dosage ratio of the magnesium source to the organic solvent is in a range of 1 mmol: 1.0-6.0 mL;
a molar ratio of the boron source to the magnesium source is in a range of 1.5-4.0:1.0; and
a molar ratio of the magnesium source to the alcohol source is in a range of 1.0:8.5-12.5.

16. The boron-based magnesium salt of claim 9, wherein the first reaction is conducted at a temperature of −5° C. to 110° C. and a pressure of 0 MPa to 15 MPa for 5 min to 180 min; and
the second reaction is conducted at a temperature of −5° C. to 110° C. and a pressure of 0 MPa to 15 MPa for 5 min to 120 min.

17. The boron-based magnesium salt of claim 9, wherein the poor solvent comprises at least one selected from the group consisting of toluene, n-hexane, cyclohexane, petroleum ether, n-pentane, isopentane, dimethylpentane, cyclopentane, isooctane, and heptane;
a volume ratio of the second reaction system to the poor solvent is in a range of 1:0.5-2;
the vacuum distillation is conducted at a temperature of 30° C. to 60° C. for 5 min to 180 min; and
the drying comprises at least one selected from the group consisting of vacuum drying and forced air drying, and the drying is conducted at a temperature of 50° C. to 90° C. for 2 h to 24 h.
